(19) United States
(12) Patent Application Publication
(10) Pub. No.: US 2013/0279378 A1
(43) Pub. Date: Oct. 24, 2013

(54) Cascaded Streaming of Data Through Virtual Chain of Nodes in Hub Topology

(71) Applicant: Razvan Daniel Niea, Mississauga (CA)

(72) Inventor: Razvan Daniel Niea, Mississauga (CA)

(73) Assignee: DELPHAX TECHNOLOGIES CANADA, LTD., Mississauga (CA)

(21) Appl. No.: 13/451,332

(22) Filed: Apr. 19, 2012

(51) Int. Cl. H04L 12/56; H04B 3/36

(52) U.S. Cl. 370/293; 370/390

(57) ABSTRACT

A method for transmitting a data file to multiple nodes in a network includes logically ordering a set of nodes connected to a switch in a hub topology to form a virtual chain of nodes and cascading a stream of data packets representing the data file from an originating node to a final node in the virtual chain of nodes. A network includes a switch and a set of nodes communicatively coupled to the switch in a hub topology, the plurality of nodes configured to form a virtual chain of nodes in a logical order, and to cascade a stream of data packets representing a data file from an originating node to a final node in the virtual chain of nodes.

### FIELD OF THE DISCLOSURE

The present disclosure relates generally to networking and more particularly to data propagation among nodes of a network.

### BACKGROUND

Hub-and-spoke, also referred to as “hub” or “star,” network topologies utilize a central switch to interconnect a number of nodes within the same network or sub-network (“subnet”). In this arrangement, in order to transfer data between one node and another node, the transmitting node transmits data packets to the central switch, which in turn routes the data packets to the destination node. As numerous data transfers between different nodes may be conducted concurrently, the switch typically has a relatively high data throughput rate or data bandwidth.

It often is the case that a data file is to be transmitted to multiple receiving nodes in the same network or sub-net. One conventional technique for achieving this multiple-destination transfer typically includes setting up individual links between the transmitting node and each destination node through the switch via a reliable connection protocol, such as via the Transmission Control Protocol/Internet Protocol (TCP/IP). However, this approach requires that multiple instances of the data file being transmitted from the transmitting node through the switch, which typically introduces data duplication and a time penalty, such as through the generation of congestion in the link between the transmitting node and the switch. Another conventional technique for achieving a multiple-destination transfer in a hub topology typically entails using the broadcast or multicast capability of, for example, the User Datagram Protocol (UDP). However, this broadcast/multicast feature in UDP and other protocols typically is a sub-optimal solution due to the unreliability inherent in these types of protocols, such as result from the dropped packets, out-of-order packets, and lack of data-integrity as permitted by UDP. Accordingly, an improved technique for transmitting a data file to multiple destinations in a network with a hub topology would be advantageous.

### BRIEF DESCRIPTION OF THE DRAWINGS

The present disclosure may be better understood, and its numerous features and advantages made apparent to those skilled in the art by referencing the accompanying drawings.

FIG. 1 is a block diagram illustrating a network with a hub topology and a technique for creating a virtual chain of nodes in the network to cascade a data stream among multiple destination nodes in accordance with at least one embodiment of the present disclosure.

FIG. 2 is a diagram illustrating a node of the network of FIG. 1 implementing a stream cascading technique between a receiver and a transmitter of a duplex network interface in accordance with at least one embodiment of the present disclosure.

FIG. 3 is a flow diagram illustrating a method for data propagation through cascaded transfer nodes in the hub network topology of the network of FIG. 1 in accordance with at least one embodiment of the present disclosure.

### DETAILED DESCRIPTION

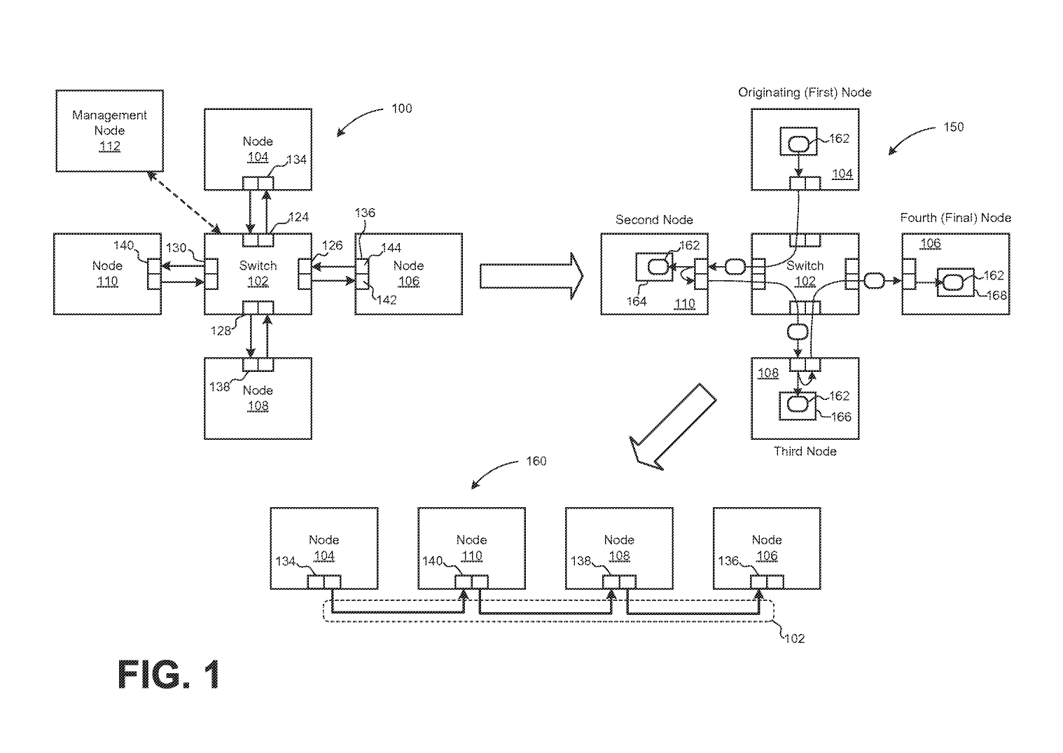

FIGS. 1-3 illustrate techniques for cascading a data file to multiple destination nodes within a network having a hub topology in a manner that avoids or reduces many of the issues presented by transmitting separate copies of the streams via TCP or by broadcasting/multicasting the stream via UDP. In one embodiment, nodes in a hub network are logically ordered in a specified sequence so as to form a virtual chain. The originating node in the virtual chain (i.e., the node initiating the data stream transfer to the multiple destination nodes) streams the data stream to the second destination node in the virtual chain via a switch. The second node receives the data packets of the stream and provides their data payloads to one or more internal components for further processing or other use. In parallel, the second node also forwards the data packets of the stream as they are received at the receiver side of the second node's network interface to the transmitter side of the second node's network interface, whereupon each data packet so forwarded is then streamed to the third node in the virtual chain in the switch. As with the second node, the third node in the virtual chain receives the data packets and provides their data payloads to one or more internal components, while concurrently forwarding each data packet from the receiver to the transmitter for transmission to the next node in the virtual chain. This process repeats for each node in the virtual chain until the last node in the virtual chain, which does not forward the data packets as they are received as there is no further destination for the data stream. Moreover, multiple virtual chains may be created from different sets or combinations of nodes or different orderings of nodes. The streaming between nodes may utilize a reliable transmission protocol, such as TCP. In this manner, the network can take full advantage of the relatively high bandwidth of the switch and the duplex nature of the nodes' network interfaces to achieve a cascaded streaming of a data file to multiple destination nodes without requiring the multiple TCP links between the originating node and the multiple destination nodes and without relying on the unreliable nature of UDP broadcast or multicast.

As an example, the data file could include backup data for a mail server or file server and the nodes could comprise backup storage devices that each receives and stores the backup data, with this duplication providing a more robust disaster-recovery in the event of a failure of the server. As the data to be backed up typically is relatively large and as the transmission preferably is reliable to ensure data integrity, the organization of the server and the backup devices in accordance with the cascaded transmission technique described herein can significantly reduce the time needed to perform the backup (and thus reduce the downtime of the server) while providing the desired transmission integrity. Another example implementation of the cascaded transmission technique disclosed herein includes the replication of a file or database between an entity's central location and its branches over a public network or dedicated communication lines.

The cascaded transmission technique disclosed herein further could be used in a scenario whereby multiple nodes otherwise would attempt to obtain or access the same file or data simultaneously. For example, a site may include a large number of diskless computers whereby at start-up each diskless computer attempts to download a boot image from a central server to local memory. In the event that these diskless computers are powered up simultaneously, the central server could be overwhelmed by simultaneous requests from the boot image from all of the diskless computers. In contrast, by cascading the diskless computers in the manner described herein, the boot image can be efficiently and effectively distributed to the diskless computers from the central server, thereby improving the boot-up times of the diskless computers.

FIG. 1 illustrates a network 100 with a hub topology and a technique for creating a virtual chain of nodes in the network so as to cascade a stream of data packets representing a data file to multiple destination nodes in accordance with at least one embodiment of the present disclosure. The network 100 includes a switch 102 and a set of nodes, such as nodes 104, 106, 108, and 110 (collectively, “nodes 104-110”). The network 100 further may include, for example, a network management node 112, which may be a separate node or implemented as one of nodes 104-110. Each of the set of nodes is linked to a corresponding interface of the switch 102 so that the set of nodes are arranged in a hub or star topology. The network 100 may comprise a complete network or a sub-net of a larger network, such as a local area network (LAN).

The switch 102 comprises any of a variety of network components used to direct packet traffic between multiple nodes, including, but not limited to, a switching hub, a switch, a router, or a bridge. Although there are debatable distinctions between these different types of network components, the term “switch”, as used herein, may refer to any of these types, or a combination thereof, as appropriate to the link technology employed to connect to the nodes in a manner that allows selective linking or routing between ports of the switch (that is, does not require broadcasting between all ports as typically is found in a Layer-1 hub). The switch 102 includes a plurality of duplex link interfaces, such as duplex ports 124, 126, 128, and 130, each communicatively coupled to a port or other network interface of a corresponding one of nodes 104, 106, 108, and 110. For improved total throughput, the switch 102 preferably has substantially symmetric upstream and downstream bandwidths.

The nodes 104-110 each includes a duplex network interface (e.g., network interfaces 134, 136, 138, and 140) communicatively coupled to a corresponding duplex port of the switch 102. To illustrate, the switch 102 could include an Ethernet switch coupled to the nodes 104-110, whereby the switch 102 and the nodes 104-110 each utilize 1000BASE-T ports which are coupled via Category 6 twisted pair cable. Each duplex network interface includes a receiver 142 and a transmitter 144 that permit concurrent reception and transmission of data packets at the network interface. The nodes 104-110 can comprise any of a variety of networked devices, such as personal computers (PCs), notebook computers, tablet computers, servers, network attached storage (NAS), networked printers, and the like. Further, one or more of the nodes 104-110 may in turn comprise a switch for connecting the network 100 to another network.

As noted above, conventional approaches to transmitting a data stream to multiple destinations in a hub topology such as that employed by network 100 typically would entail the use of multiple TCP links, one each between the originating node and a destination node, or the use of the broadcast or multicast facilities of UDP. In contrast, as illustrated by the cascaded streaming arrangement 150 of FIG. 1, three or more of the nodes of the network 100 can be configured to operate as a virtual chain whereby a stream of data packets for a data file 146 is cascaded from node to node in the logical order associated with the virtual chain, whereby each node (except for the originating and final node) receives data packets of the stream from a previous node in the virtual chain and concurrently transmits the data packets to the next node in the virtual chain. The term “data file” can refer not only to the data structure often referred to as a “file” but to any of a variety of data accumulations, conglomerations, or other structures of data.

In the depicted example, the nodes 104-110 are arranged in a virtual chain 160, whereby the node 104 is the originating node, or alpha (α) node, in the virtual chain 160, the node 110 is the second node in the virtual chain 160, the node 108 is the third node in the virtual chain 160, and the node 106 is the fourth, and final or omega (ω), node in the virtual chain 160. The originating node 104 initiates a cascading stream of data packets representing the data file 162 by identifying the next node in the virtual chain 106 (that is, node 110) and then beginning the transmission of the data packets to the next node via the switch 102. At the node 110, each data packet is received from the switch 102 at the receiver of the network interface 140 and the data payload of the data packet is provided to an internal component 164 of the node 110 for further processing. This further processing can include, for example, storing the data payload or performing some operation with the data payload. For example, the nodes 104-106 could comprise networked printers or printer servers and the data file 162 could represent a PDF file to be printed by each networked printer. In this example, the internal component 164 could include the print driver mechanism that controls the printing of the PDF file by reassembling the PDF file from the data payloads of the stream of data packets. As another example, the data file 162 could include a multimedia file and the nodes 104-106 could comprise computers or other display-enabled devices that each receives, stores, and subsequently displays a copy of the multimedia file received at the node in accordance with the cascading transmission technique described herein. In this example, the internal component 164 could include, for example, the video decoder/display subsystem, or a storage component associated with such a subsystem.

In parallel with providing the data packets of the stream to one or more internal components, the network interface 140 of the node 110 also forwards each data packet as it is received to the transmitter of the network interface 140 for transmission to the next node in the virtual chain 106 (that is, node 108) via the switch 102. As such, the node 110 in parallel receives and internally processes data packets of the stream at one or more internal components 166 while also forwarding on the data packets as they are received to the next node in the virtual chain 106. The node 108 operates in the same manner to both receive the stream of data packets and concurrently cascade the stream to the next node (that is, node 106) in the virtual chain 160 via the switch 102. The node 106, being the last node in the virtual chain 160, receives and internally processes the data packets as they are received at one or more internal components 168. However, as the node 106 is the final node in the logical order of the virtual chain 160, the network interface 136 refrains from forwarding the data packets from the receiver to the transmitter.

As illustrated by virtual chain 160, this cascading of the stream of data packets between the nodes in a predefined order permits multiple copies of the data file 162 to be distributed among the nodes 104-110 without requiring multiple TCP links from the originating node 104 and without requiring a broadcast or multicast mechanism. Moreover, this approach is relatively efficient as it leverages the concurrent receive-transmit capabilities of the duplex network interfaces of the nodes and the relatively high parallel transmission bandwidth typically found in the switch 102. To illustrate, in a Gigabit Ethernet network, the current theoretical transmission throughput between two nodes via a switch is 1 Gigabit per second (Gbps), and thus the transmission time between two nodes is at most 12 microseconds (us) per packet (as there are 81274 packets per second). Due to the nature of the duplex communication, a link between two nodes can receive data at a rate of 1 Gbps while concurrently transmitting data at the same speed. Thus, the transmission time between the originating node and any number of receiving nodes is the same as the transmission time between the originating node and one receiving node plus 12 us multiplied by the number of receiving nodes in the virtual chain (e.g., 3 receiving nodes, or 36 us in the example of FIG. 1). To illustrate, assume that t₁ representing the time, in seconds, it takes for an entire packet stream to travel in a non-cascading topology between nodes n₀ and n₁ and assume that t₂ is the time, in seconds, it takes for the same stream to travel between node n₀ and a number X of nodes (n₁ to nₓ) in the cascaded configuration described above. Also assume that Δt represents the average transmission time of a packet between any two nodes (theoretically a maximum of 12 us). In this scenario, the relationship between the time t1 and the time t2 can be represented as:

t₂=t₁+Δt*x

As time t₁ is typically at least an order of magnitude larger than Δt, the times t1 and t2 are substantially equal (i.e., t₂≅t₁). That is, the additional time needed to cascade the data stream through multiple nodes is not substantially greater than the time needed to transmit the data stream simply between two nodes.

Although FIG. 1 illustrates a single virtual chain for the network 100, in other embodiments the nodes of the network 100 may be used to form multiple virtual chains, where the virtual chains may use different sets or combinations of nodes of the network 100, different logical orderings of nodes, or combinations thereof. The different virtual chains may be implemented for a variety of reasons, such as high-priority virtual chains, low-priority virtual chains, virtual chains for a specific type of content or data, virtual chains for a specific master node, virtual chains for specific types of receiving nodes, and the like.

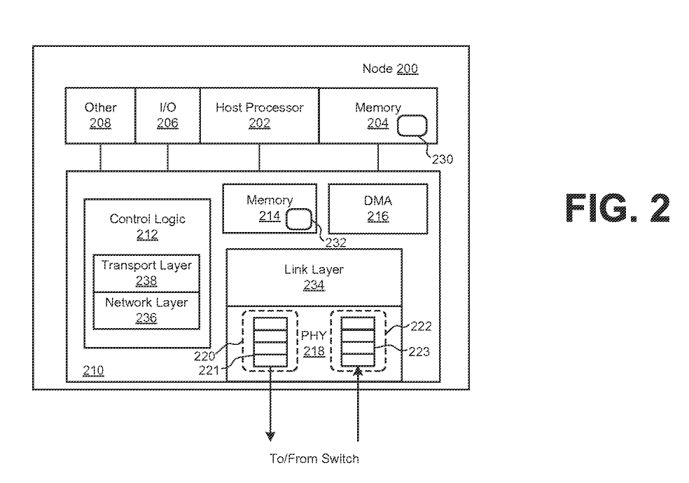

FIG. 2 illustrates an exemplary implementation of a node 200 in accordance with at least one embodiment of the present disclosure. The node 200 represents an example configuration of the nodes 104-110 in the network 100 of FIG. 1. In the depicted example, the node 200 includes a variety of internal components, such as a host processor 202, a memory 204, input/output (I/O) device 206, and other components 208. The node 200 further includes a duplex network interface 210 (e.g., a network interface card or “NIC”) having control logic 212, memory 214, a direct memory access (DMA) controller 216, and a duplex physical interface (PHY) 218. The DMA 216 operates to communicate data and control information between the host processor 202 and the control logic 212 via the memories 204 and 214. The control logic 212 is configured to control the operation of the duplex network interface 210 in accordance with one or more network protocols. The functionality of the control logic 212 may be implemented via hardware logic, via execution of firmware 232 or other software stored in memory 232 by one or more processors, or a combination thereof. The duplex PHY 218 includes transmitter circuitry 220 and receiver circuitry 222 that may be communicatively coupled to receiver circuitry and transmitter circuitry of a corresponding port of the switch 102. The transmitter circuitry 220 includes, or is associated with, an output buffer 221 used to buffer data packets waiting for transmission to the switch 102. The receiver circuitry 222 includes, or is associated with, an input buffer 223 used to buffer data packets as they arrive at the node 200 from the switch 102. The duplex PHY 218 can be implemented as a wired PHY, such as a 1000Base-T copper wire interface or a 10GBase-SR optical fiber interface, or as a wireless PHY, such as wireless Gigabit Ethernet PHY.

The higher-level operation of the node 200 is controlled via one or more software programs 230 stored in the memory 204 and executed by the host processor 202. The software programs 230 can include, for example, an operating system, an application program, and the like. As part of this higher-level operation, the internal components of the node 200 may generate data intended for transmission to one or more other nodes on the network 100 (FIG. 1) or the node 200 may be the intended recipients of data transmitted to the node 200 from one or more other nodes. The transmission of data from the node 200 to another node typically entails packetizing the data into a stream of data packets and processing the stream of data packets for physical transmission via the PHY 218 in accordance with one or more network protocols, such as TCP, UDP, and the like. Likewise, the reception of data at the node 200 typically entails depacketizing the data payloads of a stream of data packets and forwarding the data payloads to one or more internal components in accordance with one or more network protocols. The various layers of functionality of a network protocol typically are aligned or related to the seven layers of the Open Systems Interconnection (OSI) model. In the depicted example, the OSI physical layer functionality is implemented by the PHY 218, the OSI link layer functionality is implemented as hardwired link layer logic 234, and the OSI network layer functionality and transport layer functionality are implemented by the control logic 212 as network layer logic 236 and transport layer logic 238, respectively, which may be hardwired logic, firmware 232 executed by a processor, or a combination thereof. Further, in this example, upper layer functionality, such as the session layer, presentation layer, and application layer functionality, is implemented by the operating system and one or more applications executed by the host processor 202.

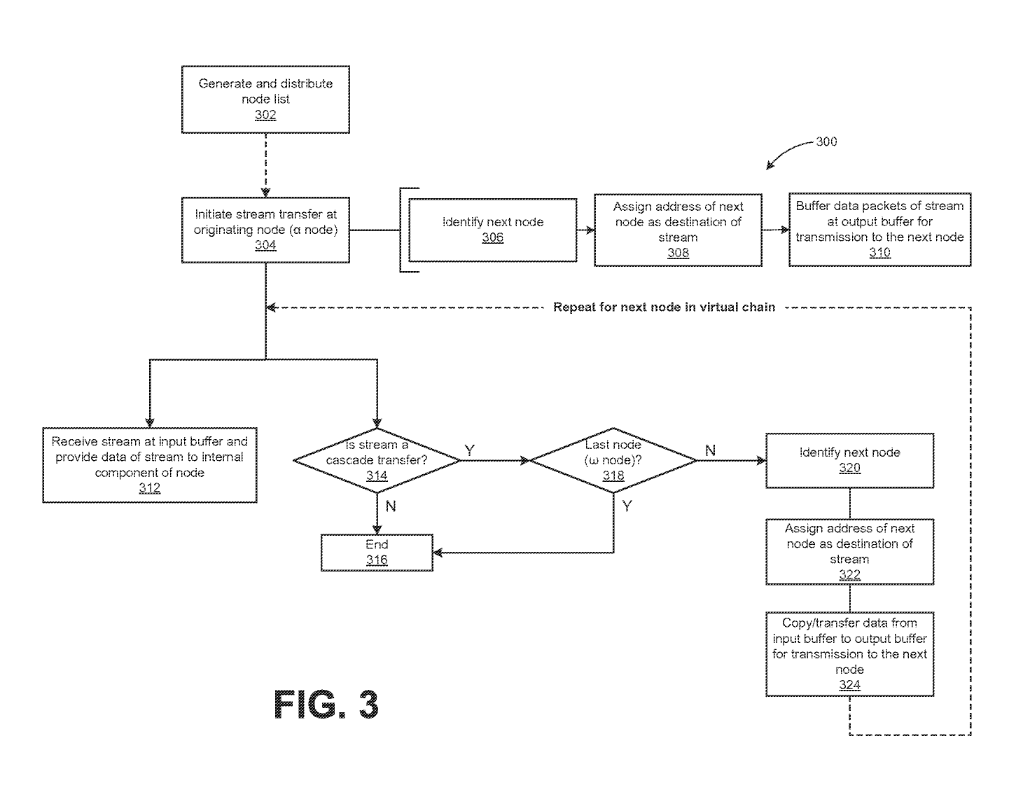

FIG. 3 illustrates a method 300 for propagation of a data file to multiple nodes in a network having a hub topology through a cascaded streaming of data packets through a virtual chain of the nodes in accordance with at least one embodiment of the present disclosure. For ease of illustration, the method 300 is described in the example contexts of the network 100 of FIG. 1 and the node 200 of FIG. 2.

Before initiating a cascaded data transfer, the method 300 initiates at block 302, in which the network 100 identifies the set of nodes 104-110 on the network 100, and determines a logical ordering of the identified nodes so as to form a virtual chain. Any of a variety of techniques may be used to discover the nodes on the network 100, including any of a variety of commercially available or proprietary network auto-discovery tool, a non-limiting example of which is described in U.S. Pat. No. 7,970,928. The auto-discovery technique may be implemented by, for example, one of the nodes 104-110 (e.g., as a master node) or by the network management node 112.

After identifying the nodes on the network 100, the management node 112 determines a logical ordering of the nodes to form a virtual chain. In one embodiment, the originating node, or alpha node, is fixed for a given virtual chain. To illustrate, in an implementation having a server that distributes the data file 162 to multiple network nodes (e.g., sending a backup file to multiple storage devices or distributing a boot image to multiple diskless computers), the server always acts as the originating node. As such, the management node 112 may have a configuration file or other configuration information identifying the server as the originating node. Alternatively, the server may be identified as the originating node based on it being a server-type node. The ordering of nodes following the originating node, up to and including the final node, or omega node, can be determined in any of a variety of ways. For example, the order may be based on IP addresses of the nodes. As another example, the order may be based on the order in which the nodes were discovered on the network. As yet another example, the order may be based on prioritizations assigned to the nodes.

In at least one embodiment, the management node 112 maintains a master list of nodes discovered in the network 100, whereby then master list can include information identifying the logical ordering of the nodes for one or more virtual chains represented in the network 100. The node list may be generated from the discovered nodes in any of a variety of ways. For example, as each node is discovered through the network auto-discovery mechanism and configured for the network through any of a variety of configuration protocols, the discovered node is added to the next open entry in the node list, along with the address information of the node, the node's relative position in a virtual chain, and any other appropriate characteristics or identifiers. To illustrate, in a TCP/IP implementation whereby the nodes are addressed in the network 100 via a corresponding IP address, the node list could include, for each discovered node, a node identifier (such as the list entry number) the local IP address of the node, the local node IP port used for the virtual chain, and the IP address and IP port of the next node in the virtual chain (referred to herein as the “next node IP address” and “next node IP port”, respectively). As another example, the address information included in the node list could include a media access control (MAC) address of the node in a media access control (MAC)-based addressing scheme. Table 1 illustrates an example node list generated from a network auto-discovery and configuration process at block 302:

TABLE 1
Example Node List

| Entry | | Local Node | Local Node | Next Node IP | Next Node |
|---|---|---|---|---|---|
| No. | Name | IP address | IP port | address | IP port |
| 1 | Node | Any | 0 | 192.168.1.11 | 16385 |
| | 104 | | | | |
| 2 | Node | 192.168.1.11 | 16385 | 192.168.1.18 | 35127 |
| | 110 | | | | |
| 3 | Node | 192.168.1.18 | 35127 | 192.168.1.17 | 24283 |
| | 108 | | | | |
| 4 | Node | 192.168.1.17 | 24283 | Any | 0 |
| | 106 | | | | |

In the example of Table 1, the nodes are ordered in the node list in the same order of the virtual chain 160 for ease of illustration. The null local node IP port for node 104 indicates that node 104 is the originating node. Similarly, the null next node IP port indicates that node 106 is the last node on the virtual chain. In the event there are multiple virtual chains, there may be a separate table for each virtual chain, or a table may be represent multiple virtual chains, whereby each node is configured to identify the next node IP address and next node IP port for a virtual chain based on the IP port of the node at which the data packets are received.

Representations of the logical ordering of the nodes for a virtual chain may be communicated to the nodes 104-110 in a variety of ways. To illustrate, in one embodiment, the management node 112 informs each node of a virtual chain of the its next node IP address and next node IP port via a handshake or negotiation process when, for example, the node receives a node-specific configuration from the management node 112 for the network 100 in response to the discovery of the node through a network auto-discovery mechanism. In another embodiment, the node list may be transmitted as a header of one or more packets at the beginning of a data stream to be cascaded such that the node list is cascaded to each node in the virtual chain in turn.

Periodically, a node may be disconnected from the network 100 or otherwise rendered unsuitable for use in the virtual chain 160. Accordingly, the management node 112 monitors the nodes active on the network 100, and when a node is disconnected or otherwise rendered inoperable, the management node 112 may remove the node from the virtual chain 160 and modify the virtual chain 160 to maintain the continuity of the virtual chain 160. The continuity can be maintained by, for example, configuring the node upstream of the removed node to identify the node downstream of the removed node as the respective next node in the chain. Alternatively, the management node 112 can introduce a replacement node in the place of the removed node, such that the upstream node identifies the replacement node as the respective next node in the virtual chain, and the replacement node identifies the downstream node as the respective next node in the virtual chain. When the management node 112 has modified the virtual chain 160 to remove a node, the remaining affected nodes can be updated through node-specific configurations via a handshake process with the management node 112 as described above.

After the nodes of the virtual chain 160 are configured, the originating node, as master node or alpha node of the virtual chain 160, can initiate a cascade of data packets representing a data file, such as data file 162 of FIG. 1, to multiple nodes in the network 100 at block 304. This process includes the originating node identifying the next node in the virtual chain 160 from its local configuration file at block 306. As illustrated by Table 1, and as adopted for purposes of the following description, the node 104 is the originating node and thus the next node for node 104 in the logical order of the virtual chain 106 is node 110. The network interface 210 of the originating node 104 then assigns as the destination address and destination IP port of each data packet the next node IP address (192.168.1.11) and the next node IP port (16385) as represented in the entry for node 104 in Table 1 at block 308. At block 310, the originating node (node 104) buffers the data packets at the output buffer 221 of the network interface 210 for subsequent transmission to the next node (node 110) via the switch 102.

At block 312 the network interface 210 of the receiving node buffers each data packet received from the preceding node at the input buffer 223, depacketizes the data payload, and provides the data payload to one or more internal components of the receiving node for further processing. For example, the data payloads may be provided to an application executed by the host processor, stored at a storage device, etc. Concurrently, at block 314 the network interface 210 of the receiving node determines whether the stream of packets is a cascaded stream (i.e., a stream to be cascaded down the virtual chain 160) or a stream of packets terminating at the receiving node (e.g., a conventional point-to-point TCP transmission). In one embodiment, the receiving node identifies each data packet as being part of a cascaded stream and, if there are multiple virtual chains in the network 100, identifies the virtual chain for the cascaded stream based on the IP port at which the data packet was received. In an alternative embodiment embodiment, the receiving node identifies each data packet as being part of a cascaded stream based on an identifier in a field of the header of the packet. In yet another embodiment, the cascade stream may be identified by a start cascade data packet and an end cascade data packet, and each data packet received in between from the same upstream address is treated as part of the cascade stream. Alternatively, the network 100 may be configured such that all packet streams are treated as cascaded streams by default.

If the data packets are identified as being part of a non-cascaded stream (e.g., part of a single transmission or a multicast/broadcast), at block 316 the network interface 210 of the receiving node takes no further action with respect to retransmission of the received data packets. Conversely, if the data packets are identified as being part of a cascaded stream, at block 318 the receiving node determines whether it is the last node in the logical order of the virtual chain 160. For example, a receiving node can determine that it is the final, or omega, node in the virtual chain 160 if it has a null or 0.0.0.0 value for its next node IP address. In the event that the receiving node determines that it is the last node in the virtual chain 160, the receiving node returns to block 316 and takes no further action with respect to retransmission of the received data packets. Otherwise, if there is at least one more downstream node, at block 320 the receiving node identifies the next node in the virtual chain 160, such as by identifying the next node IP address and next node IP port from the configuration information provided to the receiving node by the management node 112. At block 322 the network interface 210 assigns the next node IP address and next node IP port as the destination address and IP port, respectively, of the data packets of the cascaded stream, and at block 324 the network interface 210 copies or otherwise transfers each data packet of the cascaded stream from the input buffer 223 to the output buffer 221 as the data packet is received (with the data packet, or a copy thereof, also going to the internal components of the node as described at block 310). As part of this copy or transfer process, the network interface 210 replaces the previous destination address and IP port of the copied/transferred data packet with the destination address and IP port of the next node as identified at block 316. The data packet is then transmitted to the switch 102 for transmission to the next node in the virtual stream. The process of blocks 312, 314, 316, 318, 320, 322, and 324 repeats for each downstream node in the virtual chain 160 until the last node receives the stream of packets, as described above with respect to block 318.

In this document, relational terms such as “first” and “second”, and the like, may be used solely to distinguish one entity or action from another entity or action without necessarily requiring or implying any actual relationship or order between such entities or actions or any actual relationship or order between such entities and claimed elements. The term “another”, as used herein, is defined as at least a second or more. The terms “including”, “having”, or any variation thereof, as used herein, are defined as comprising.

Other embodiments, uses, and advantages of the disclosure will be apparent to those skilled in the art from consideration of the specification and practice of the disclosure disclosed herein. The specification and drawings should be considered as examples only, and the scope of the disclosure is accordingly intended to be limited only by the following claims and equivalents thereof.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed.

Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

What is claimed is:

1. A method for transmitting a data file to multiple nodes in a network, the method comprising:
logically ordering a set of nodes connected to a switch in a hub topology to form a virtual chain of nodes; and
cascading a stream of data packets representing the data file through the virtual chain of nodes.

2. The method of claim 1, wherein logically ordering the set of nodes to form the virtual chain comprises:
determining a logical order of the set of nodes; and
configuring the nodes of the set to implement the logical order.

3. The method of claim 2, wherein configuring the nodes of the set to implement the logical order comprises:
configuring each node of the set with a corresponding next node network address that identifies a network address of the respective next node in the logical order.

4. The method of claim 3, wherein configuring the nodes of the set to implement the logical order further comprises:
configuring each node of the set with a corresponding next node port that identifies a port of the respective next node in the logical order, and whereby the last node in the logical order is configured with a predetermined value for the next node port address.

5. The method of claim 3, further comprising:
employing a network auto-discovery mechanism to discover nodes on the network; and
wherein configuring the nodes of the set to implement the logical order comprises configuring each node to implement the logical order as part of a network configuration process for the node in response to discovering the node on the network.

6. The method of claim 3, wherein cascading the stream of data packets comprises:
identifying, at a second node of the set, a third node of the set as a next node in the virtual chain based on a next node network address configured for the second node;
receiving, at a duplex network interface of the second node, a data packet of the stream from a first node of the set via the switch; and
transmitting the data packet from the duplex network interface of the second node to the third node via the switch, the data packet including as a destination port the next node port configured for the second node.

7. The method of claim 6, further comprising:
providing a data payload of the data packet from the duplex network interface to an internal component of the second node concurrent with identifying, receiving, and transmitting.

8. The method of claim 2, wherein cascading the stream of data packets comprises:
identifying, at a second node of the set, a third node of the set as a next node in the virtual chain based on the logical order;
receiving, at a duplex network interface of the second node, a data packet of the stream from a first node of the set via the switch; and
transmitting the data packet from the duplex network interface of the second node to the third node via the switch.

9. The method of claim 8, further comprising:
providing a data payload of the data packet from the duplex network interface to an internal component of the second node concurrent with identifying, receiving, and transmitting.

10. The method of claim 8, wherein cascading the stream of data packets further comprises:
identifying, at the third node, a fourth node of the set as a next node in the virtual chain based on the logical order;
receiving, at a duplex network interface of the third node, the data packet from the second node via the switch; and
transmitting the data packet from the duplex network interface of the third node to the fourth node via the switch.

11. The method of claim 1, wherein the set of nodes comprises a first set of nodes, the virtual chain comprises a first virtual chain, the stream of data packets comprising a first stream of data packets, the data file comprising a first data file, and the method further comprises:
logically ordering a second set of nodes connected to the switch in a hub topology to form a second virtual chain of nodes; and
cascading a second stream of data packets representing a second data file through the second virtual chain of nodes.

12. A network comprising:
a switch; and
a set of nodes communicatively coupled to the switch in a hub topology, the set of nodes configured to form a virtual chain of nodes in a logical order, and to cascade a stream of data packets representing a data file through the virtual chain of nodes.

13. The network of claim 12, further comprising a management node coupled to the switch, the node configured to determine a logical order of the set of nodes and to configure the nodes of the set to implement the logical order.

14. The network of claim 13, wherein the management node is to configure the nodes of the set to implement the logical order by configuring each node of the set with a corresponding next node network address that identifies a network address of the next node in the logical order.

15. The network of claim 14, wherein the management node is to configure the nodes of the set to implement the logical order further by configuring each node of the set with a corresponding next node port that identifies a port of the next node in the logical order, and whereby the last node in the logical order is configured with a predetermined value for the next node port address.

16. The network of claim 14, wherein the set of nodes is configured to cascade the stream of data packets by identifying, at a second node of the set, a third node of the set as a next node in the virtual chain based on a next node network address configured for the second node, by receiving, at a duplex network interface of the second node, a data packet of the stream from a first node of the set via the switch, and by transmitting the data packet from the duplex network interface to the third node via the switch.

17. The network of claim 16, wherein the second node further is configured to provide a data payload of the data packet from the duplex network interface to an internal component of the second node concurrent with identifying, receiving, and transmitting.

18. The network of claim 17, wherein the set of nodes is configured to cascade the stream of data packets further by identifying, at the third node, a fourth node of the set as a next node in the virtual chain based a next node network address configured for the third node, by receiving, at a duplex network interface of the third node, the data packet from the second node via the switch, and by transmitting the data packet from the duplex network interface of the third node to the fourth node via the switch.

19. The network of claim 12, wherein the set of nodes comprises a first set of nodes, the logical order comprises a first logical order, the virtual chain comprises a first virtual chain, the stream of data packets comprising a first stream of data packets, the data file comprising a first data file, and the network further comprises:
a second set of nodes communicatively coupled to the switch in a hub topology, the second set of nodes configured to form a second virtual chain of nodes in a second logical order, and to cascade a second stream of data packets representing a second data file through the second virtual chain of nodes.

20. A node comprising:
an internal component; and
a duplex network interface coupleable to a corresponding port of a switch, wherein the duplex network interface is configured to participate in a cascading of a stream of data packets representing a data file from an originating node to a final node in a virtual chain of nodes represented by a logical ordering of a set of nodes coupled to the switch in a hub topology, the set of nodes comprising the node.

21. The node of claim 20, wherein the node comprises a second node of the set, and the network interface is configured to identify a third node of the set as a next node in the virtual chain based on the logical ordering, to receive a data packet of the stream from a first node of the set via the switch, and to transmit the data packet to the third node via the switch.

22. The node of claim 21, wherein the duplex network interface is configured to provide a data payload of the data packet to an internal component of the second node concurrent with identifying the third node, receiving the data packet, and transmitting the data packet.

23. The node of claim 21, wherein:
the duplex network interface is configured to receive a node configuration, the node configuration c identifying a next node network address for a next node in the logical ordering relative to the node; and
the duplex network interface is configured to identify the third node of the set as the next node based on next node network address.

24. The node of claim 20, wherein the duplex network interface includes:
an input buffer associated with receiver circuitry;
an output buffer associated with transmitter circuitry; and
control logic configured to transfer the data packet from the input buffer to the output buffer in response to determining the data packet is part of the stream to be cascaded in the virtual chain of nodes.
